(19) United States
(12) Patent Application Publication
(10) Pub. No.: US 2020/0264036 A1
(43) Pub. Date: Aug. 20, 2020

(54) Enclosure for a sound level meter and a sound level meter

(71) Applicant: Teknologian tutkimuskeskus VTT Oy, Espoo (FI)

(72) Inventor: Panu Maijala, Tampere (FI)

(21) Appl. No.: 16/758,871

(22) PCT Filed: Oct. 17, 2018
(86) PCT No.: PCT/FI2018/050759

§ 371 Date: Apr. 24, 2020

(30) Foreign Application Priority Data
Oct. 27, 2017 (FI) 20175954

(51) Int. Cl. G01H 3/14; H04R 1/02

(52) U.S. Cl. CPC G01H 3/14; H04R 1/021

(57) ABSTRACT

A sound level meter enclosure is herein proposed particularly for facilitating the measurement of environmental noise. The novel enclosure includes a microphone housing which is provided to a bottom surface of the enclosure. The enclosure also has a stand which is configured to provide a clearance between the microphone housing and an installation surface on which the enclosure is to be placed.

### FIELD

This disclosure relates to noise measurement. In particular, the disclosure relates to devices for the permanent sound level measurement of environmental noise.

### BACKGROUND

Environmental noise is a common problem associated with traffic and industry. The problem may even prevent new technologies from being utilized and spread. A prominent example is the production of wind power. To meet the prevailing noise restrictions, wind turbines are specifically designed to minimize noise emitted by the turbine mechanism such to comply with the local standards for environmental noise levels. The determination of whether or not a given wind turbine or production plant is within the acceptable limits is to apply a standard for measuring and assessing environmental noise. The international standard for such measurements is, at the time of filing of the present application, Part 2 of ISO 1996-2:2007. The international standard defines how the microphone of the sound level meter is placed to achieve a reliable reading. According to the international standard, the sound level meter should be placed on an acoustically reflective surface such that the microphone rests against the reflective surface with the transducer extending orthogonally in respect to the reflective surface.

The international standard may be supplemented and specified by local regulation. For example, the instruction for measuring environmental noise in areas subject to wind turbine noise issued by the Ministry of the Environment of Finland (Tuulivoimaloiden melutason mittaaminen altistuvassa kohteessa, Ympäristöhallinnon ohjeita 4/2014, Ympäristöministeriö, Rakennetun ympäristön osasto, Helsinki 2014, ISSN 1796-1653, see particularly section 4, pages 12 to 13). The instruction defines, i.a., that the acoustically reflective surface (203) should be circular with a diameter of at least one meter, that the microphone (200) should rest against the acoustically reflective surface (203) with the transducer (201) being orthogonal to the acoustically reflective surface (203), and that the microphone (200) should be covered by at least one wind shield (202). FIG. 8 illustrates a schematic side elevation view of such of a measurement arrangement. According to the instruction of the Ministry of the Environment of Finland measurements several should be taken at different times of the day. The current devices for measuring sound levels, when left resting on the acoustically reflective surface, therefore require that an operator is present for extended periods of time to ensure the integrity of the measurement.

Accordingly, there remains a need for a sound level measuring device which would not only be suitable for unattended periods of measurement but also be capable of taking reliable environmental noise measurements without being compromised by the elements, such as wind.

### SUMMARY OF THE INVENTION

A novel enclosure for a sound level meter is herein proposed. The enclosure includes a microphone housing which is provided to a bottom surface of the enclosure. The enclosure also has a stand which provides a clearance between the microphone housing and an installation surface on which the enclosure is to be placed.

The invention is defined by the features of the independent claims. Some specific embodiments are defined in the dependent claims.

Considerable benefits are gained by virtue of the novel design. Because the microphone is shielded from the elements and tampering by the enclosure, the sound level meter can be left unattended to gather measurement data for extended periods of time. The long measurement durations improve the quality of measurement data of environmental noise as periodic highs and lows are levelled out from the data. Such unattended measurement opens up further possibilities and benefits, such as reliable measurement in areas, the environmental noise of which has previously only been modelled. Also, measurements can be taken unattended at several different locations simultaneously, whereby the measurements may introduce a spatial aspect to the outcome as well as further improve the representativeness of the measurement.

From a constructional point of view, the position of the microphone at the bottom end of the enclosure brings the microphone close to the reflective surface on which the effect of wind is very close to zero.

Further benefits associated with particular embodiments are described in connection with such embodiments.

### BRIEF DESCRIPTION OF THE DRAWINGS

In the following certain exemplary embodiments are discussed in greater detail with reference to the accompanying drawings in which:

FIG. 1 illustrates a bottom perspective view of a sound lever meter in accordance with at least some embodiments of the present invention;

FIG. 2 illustrates a side elevation view of the sound level meter of FIG. 1;

FIG. 3 illustrates a front elevation view of the sound level meter of FIG. 1;

FIG. 4 illustrates a bottom elevation view of the sound level meter of FIG. 1;

FIG. 5 illustrates a sketched version of FIG. 4 showing imaginary tangential lines and their respective symmetrical axes;

FIG. 6, illustrates a cross-sectional view taken along the line AA of the sound level meter of FIG. 5;

FIG. 7 illustrates a detailed view of area B of FIG. 6, and

FIG. 8 illustrates a schematic side elevation view of a measurement arrangement according to the prior art.

### DETAILED DESCRIPTION OF EXEMPLARY EMBODIMENTS

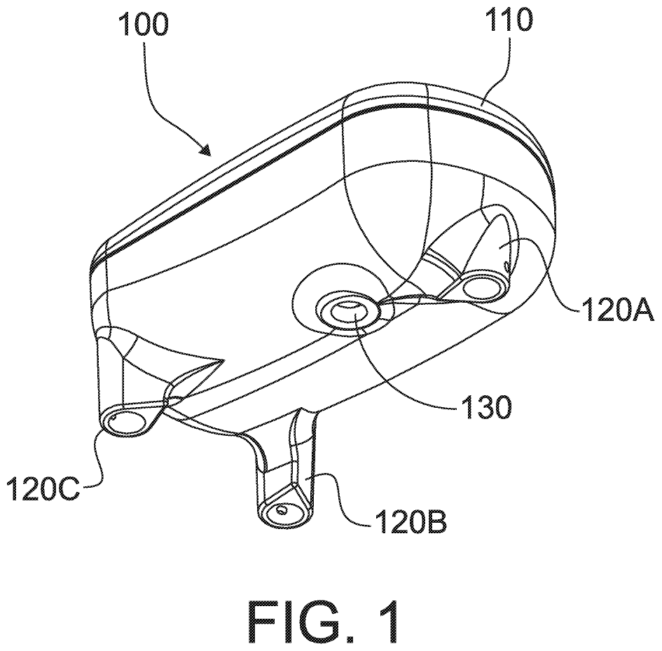

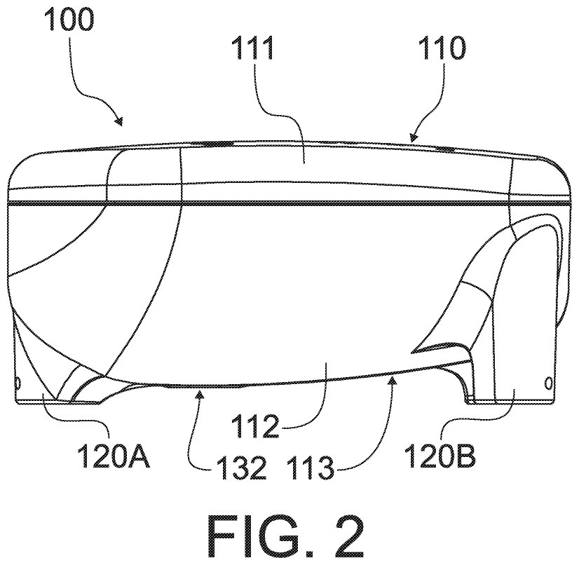

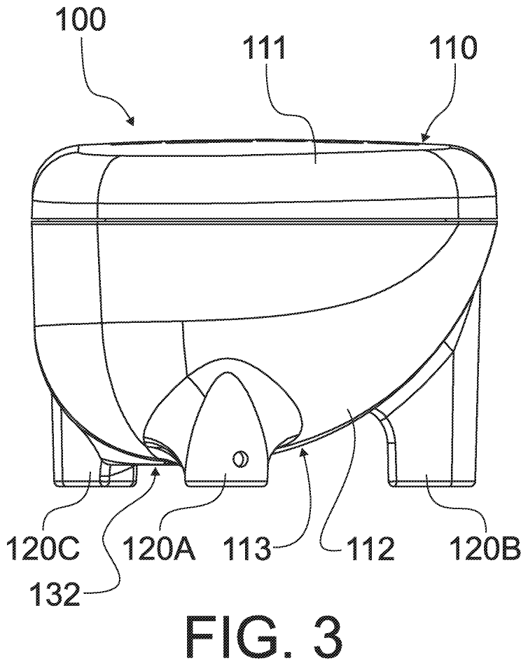

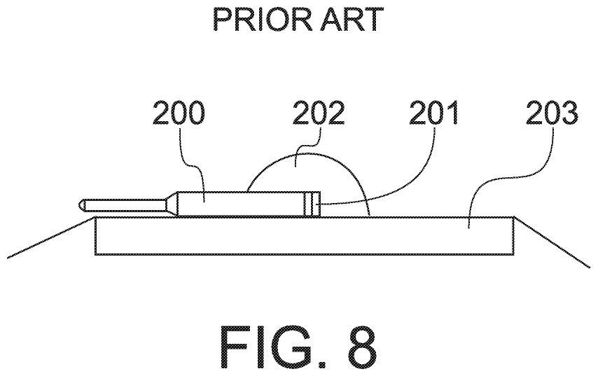

FIG. 1 illustrates an exemplary sound level meter 100 from below in a perspective view. The enclosure 110 of the sound level meter 100 is designed to be installed or left to the measuring point for extended periods of time to collect environmental noise level measurements. In other words, the sound level meter 100 is intended for permanent or semi-permanent installation. In the present context, the expression semi-permanent refers to an unattended period of time, e.g. one day or more, and permanent to a time period of one month or more. The benefit of a long measurement period is to gain a true representation of environmental noise independent of periodic highs and lows. The enclosure 110 is a drastic departure from the established measurement arrangement shown in FIG. 8 in that the enclosure 110 contains the microphone in a microphone housing 130 which is placed to the bottom surface 113 of the enclosure 110. The bottom surface 113 is the part of the enclosure 110 that faces the installation surface. FIGS. 2 and 3, which are side and front elevation views of the sound level meter 100, respectively, show how the bottom surface 113 of the bottom component 112 of the enclosure 110 is elevated from the installation surface by a stand 120. The FIGURES show a horizontal installation, wherein the clearance is vertical. Naturally, the sound level meter 100 could alternatively be installed in an arbitrary orientation making the clearance direction non-vertical, e.g. horizontal in wall installations. In the shown embodiment the stand 120 which is composed of three separate legs (generally denoted 120A, 120B, 120C to indicate the formation of the stand) that extend from the bottom component of the enclosure. The clearance provides for a sound path to be formed between the enclosure 110 and the installation surface. On the other hand, placement of the microphone housing 130 to the bottom surface 113 of the enclosure 110 provides for protection of the microphone from the elements and from tampering.

According to an embodiment, one or several microphone housings is/ar provided only to the bottom surface 113 of the enclosure 110.

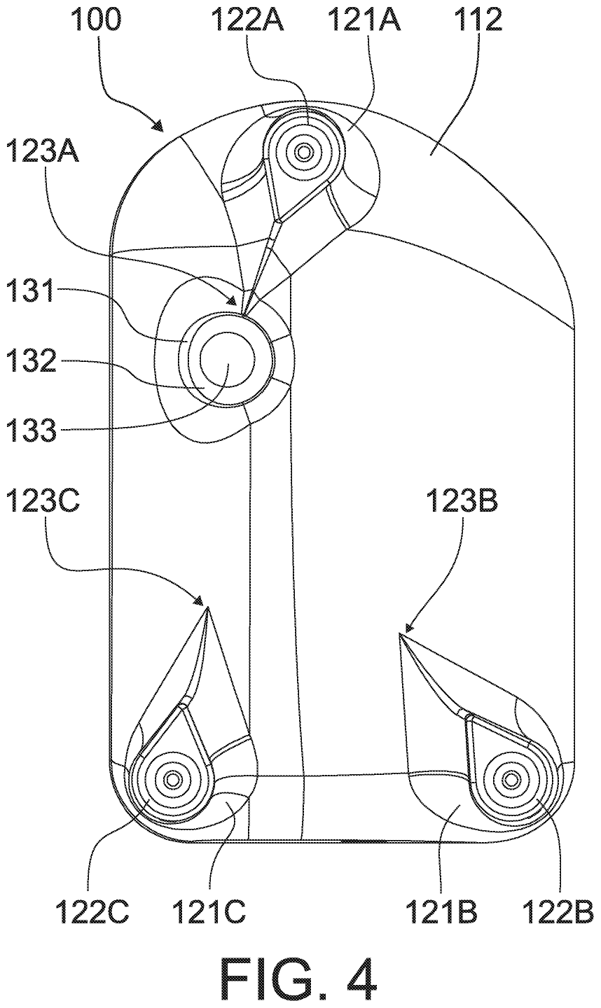

FIG. 4, which is a bottom elevation view of the sound level meter 100, shows an elucidating illustration of the design of the microphone housing 130 and the stand 120. The microphone housing 130 is an open enclosure integrated into the bottom component 112 of the enclosure 110. FIGS. 1 to 5 show the sound level meter 100 without a microphone so as to illustrate that the microphone housing 130 is suited to facilitate installation of a microphone into the opening 133. The microphone housing 130 includes a body 131 which in the illustrated example has a generally cylindrical shape. The body 131 may be integrated into the bottom component 112 of the enclosure 110 or it may extend from or be partly embedded into the bottom surface 113 of the enclosure 110.

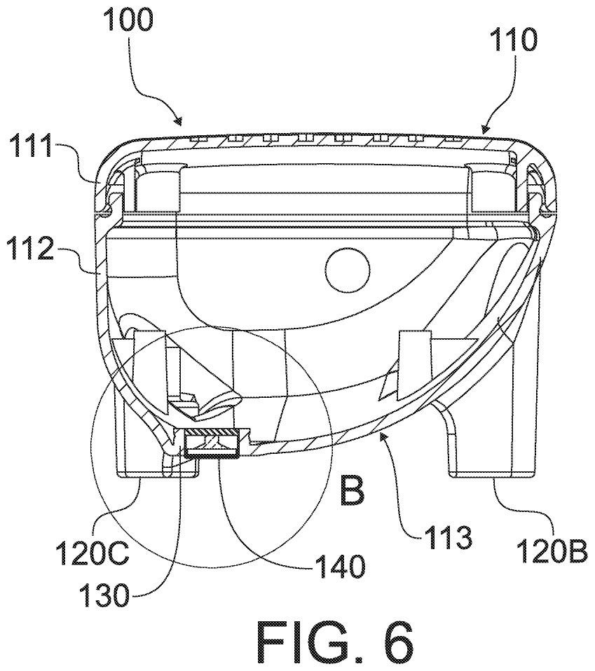

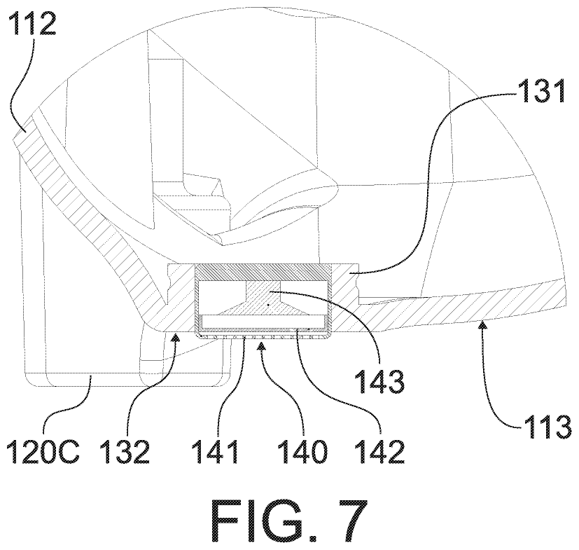

The mutual relationship between the microphone housing 130 and the microphone 140 is best illustrated in FIGS. 6 and 7 showing also the microphone 140. The body 131 includes a cavity for accommodating a microphone 140. In the shown example the microphone 140 has a generally cylindrical shape, whereby the body 131 features a similarly shaped cavity. The cavity terminates to an opening 133 (FIG. 4). The microphone housing 130 features an end surface 132. When the sound level meter 100 is installed onto the acoustically reflective installation surface the end surface 132 of the microphone housing 130 is parallel to the installation surface. In this context the word parallel is to be understood as including not only the exact parallel orientation but also slight or practical deviations up to, for example, 10 degrees or such that the difference in distance between the point closest to the reflective surface and the point farthest from the reflective surface is at most 6 mm. There is an opening 133 made to and defined by the end surface 132. The opening 133 connects the transducer 142 of the microphone 140 embedded in the microphone housing 130 to the sound path created underneath the enclosure 110, i.e. between the bottom surface 113 of the enclosure and the acoustically reflective installation surface on which the sound level meter 100 is installed.

In the shown example, the transducer 142 of microphone 140 is installed flush with the end surface 132 of the microphone housing 130. The grid of the microphone case 141 therefore protrudes from the end surface 132 of the microphone housing 130. One could therefore say that the microphone case 141 protrudes from the bottom surface 113 of the enclosure 110. Alternatively, the microphone case 141 could be flush with the end surface 132 of the microphone housing 130 or embedded thereto so as to protect the diaphragm. The microphone 140 as a component is preferably selected according to the intended measurement spectrum as certain models are more suitable for infrasound range than for the audible range or more suitable for a relatively low volume range than for a high volume range, for example. The transducer 142 is preferably relatively close to the acoustically reflective installation surface without contact. For example, preferred distance between the transducer 142 of the microphone 140 from the installation surface is 10 mm or less, preferably between 2 and 5 mm. In any case it is preferred that the transducer 142, more specifically the diaphragm of the transducer, is parallel to the acoustically reflective installation surface beneath the enclosure 110. Such a setup is in direct non-conformity with the prevailing standards. The new configuration does, however, enable significant additional benefits. By enclosing the microphone 140 to an upwardly extending enclosure, which in turn may be acoustically optimized in design, there is very little or virtually no limit to the transducer size. Accordingly, the standard transducer diameter of 13 mm may be increased to, for example, 1 inch or more to gain greater sensitivity and higher frequency band extending, for example, past 10 kHz. By contrast, typical transducers with a 13 mm diameter can only reach frequencies up to 4 kHz. According to the international standard, if the frequency range is to be expanded above 4 kHz, a 6 mm microphone should be used. The 6 mm microphone is limited to about 8 kHz. Preferably, the microphone is omnidirectional.

The enclosure 110 contains space above the microphone housing 130 for the electronics used for operating the microphone, including, for example, a pre-amplifier, a voltage source, an analogue-digital transformer, a processing core, a microcontroller for recording, a power reserve, and/or a network interface for providing a data connection for outputting the measurement data. Accordingly, all the components needed for environmental noise measurement is protected by the elements and tampering. Also, the enclosure 110 may be fitted with a power terminal at for receiving external power.

As mentioned above, the stand 120 comprises a plurality of supports which in the illustrated example take the form of legs 121A, 121B, 121C which exhibit a rotationally non-symmetrical shape. The shape of the legs 121A, 121B, 121C is optimized such to create as little turbulence as possible. Also, the design principles have the aim of avoiding planar surfaces on the enclosure that would be parallel to the microphone so as to avoid reflections directed towards the microphone. Accordingly, an eccentric or sharp cam shape or a droplet shape is favoured such that the legs 121A, 121B, 121C each include a narrow tip 123A, 123B, 123C at an end of the cross-section closest to the microphone housing 130 and a wider distal end at the other. The tips 123A, 123B, 123C are oriented to point towards the microphone housing 130. Also the transition between the curved distal end and the tapering tip 123A, 123B, 123C is made as smooth as possible to ensure fluent air flow past the legs 121A, 121B, 121C. It is also preferred that the height of the legs is adjustable by means of telescopic or detachable elements (not shown) to adjust the distance between the transducer of the microphone and the acoustically reflective surface. The bottom surfaces 122A, 122B, 122C of the legs 121A, 121B, 121C may act as fixing points of the sound level meter 100. The bottom surfaces 122A, 122B, 122C may, for example, receive screws through the acoustically reflective installation surface, adhesive there between, a Velcro counterpart, or the like. Alternatively, the bottom surfaces 122A, 122B, 122C may comprise prominent fixing means, such as screws, spikes, etc. The enclosure may further be isolated from the reflective surface by installing a vibration isolator between the stand 120 reflective surface. The vibration isolator is configured to prevent vibrations of the reflective surface from travelling to the enclosure. The stand 120 may for this purpose comprise receptive openings for accommodating the vibration isolators which, in turn, are affixed to the reflective surface. Suitable vibration isolators may be made from elastic materials, such as rubber, silicone, or the like.

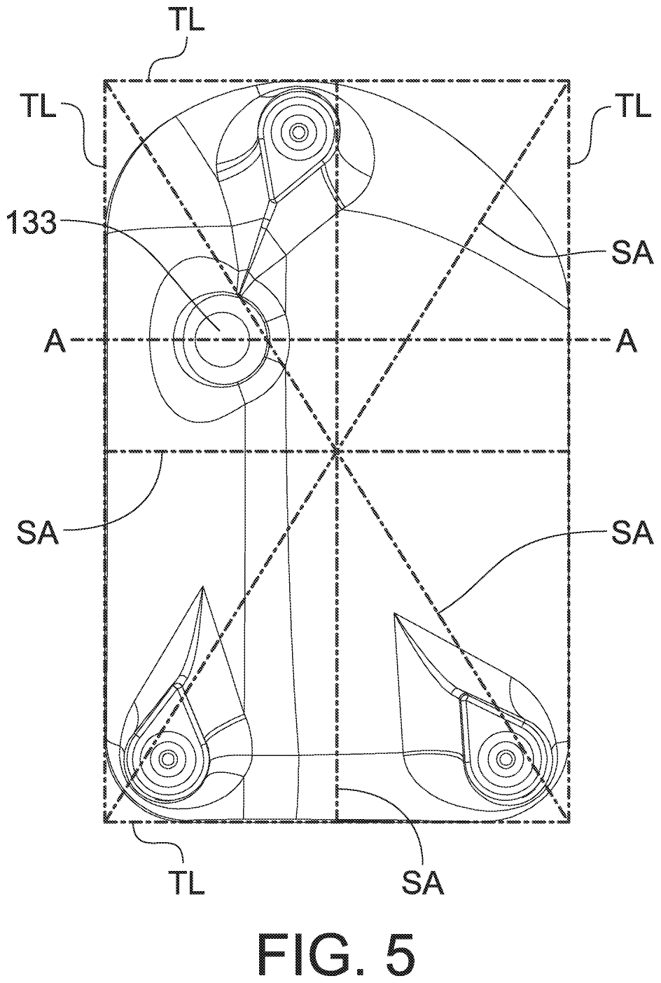

FIG. 4 also reveals that the enclosure 110 is designed to exhibit a shape that is as asymmetrical as possible in respect to the microphone housing 130 as possible. Ultimately this asymmetry will benefit the microphone in that sound waves will arrive to the point of measurement at different times to avoid summation of signals. FIG. 5, which is an augmented bottom elevation view of the enclosure 110, illustrates the asymmetry with sketched imaginary lines. Firstly it is to be noted that the bottom elevation view of FIG. 5 represents the projection of the enclosure 110 on the acoustical reflective installation surface of the sound level meter 100. As may be seen, the projection has a generally quadrilateral shape with a widely rounded top right corner, a moderately rounded top left corner, and tightly rounded bottom left and right corners. Alternatively, some of the corners could be chamfered or otherwise shaped so as to avoid right angles and thus prismatic overall shape of the enclosure. The purpose of the lightened edges is to avoid turbulence or to minimize the kinetic energy of turbulence occurring in the vicinity of the microphone 140.

With the projection of the enclosure imagined on the acoustical reflective installation surface let us then imagine tangential lines TL drawn on the projection so as to form a polygon that is as close to the shape of the projection as possible. In the shown example, the tangential lines TL form a quadrangle. Let us then establish symmetry axes SA for the formed polygon of tangential lines TL. In the given example, four symmetry axes SA split the polygon vertically, horizontally, and diagonally. With the symmetry axes SA in place it may be noted that the microphone housing 130 is placed such to be offset from all symmetry axes SA. The microphone housing 130 may, of course, overlap with a symmetry axis SA, such as the diagonal symmetry axis SA connecting the top left and bottom right corner of the illustrated polygon. It is, however, the preferred design principle that the microphone housing 130 is offset enough that the center point of the microphone transducer is not on a symmetry axis SA. In other words, the acoustic axis or center point of the microphone is offset from the symmetry axes SA. The same holds true for the stand 120. As shown in FIG. 5, also the cross-sectional center points of the legs 121A, 121B, 121C are offset from the symmetry axes SA. It may transpire that for practical reasons the microphone or the stand may not be offset from each of the symmetry axes SA. In such eventualities it is however preferred that the offset is made to as many symmetry axes SA as possible to at least maximize asymmetry.

The proposed asymmetrical and preferably rounded design provides for a shape that facilitates stable interaction with ambient winds acting on the sound level meter 100. As the bottom surface 113 of the enclosure is quite close to the installation surface, the flow is accelerated in the space between the bottom surface 113 of the enclosure 110 and the installation surface. Wind flowing underneath the enclosure 110 is, however, relatively stable thus minimizing additional wind noise at the microphone housing 130 that would influence the measurement of environmental noise. Naturally, the stand 120 will cause some trailing turbulence but such phenomenon will not significantly impact the environmental noise because the microphone housing 130 is located to an area of the bottom surface 113.

Referring to FIGS. 2, 3 and 6 it is noteworthy to point out that the enclosure 110 is preferably made from two or more interconnecting parts. In the shown example the enclosure 110 is assembled from a top component 111 and a bottom component 112 which are connected to each other at a peripheral seam. The top component 111 and the bottom component 112 therefore not only create a large opening providing easy access inside the enclosure 110 for assembly purposes but also enable additive manufacturing by means of 3D printing, for example. The top and bottom components 111, 112 may be connected to each other at the seam preferably by use of an adhesive to prevent unauthorized opening. Also, the bottom component 112 of the enclosure 110, which contains the stand 120 and the microphone housing 130, may be manufactured from the “seam up” so that the first layer of material is the widest top end of the bottom component 112 of the enclosure 110 which provides support for following layers which terminate to the stand 120, microphone housing 130, and the bottom surface 113. The same applies to the top component 111 of the enclosure 110.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

REFERENCE SIGNS LIST

| No | Element |
|---|---|
| 100 | sound level meter |
| 110 | enclosure |
| 111 | top component |
| 112 | bottom component |
| 113 | bottom surface |
| 120 | stand |
| 121 | envelope |
| 122 | bottom surface |
| 123 | tip |
| 130 | microphone housing |
| 131 | body |
| 132 | end surface |
| 133 | opening |
| 140 | microphone |
| 141 | case |
| 142 | transducer |
| 143 | stator |
| SA | symmetry axis |
| TL | tangential line |

### CITATION LIST

[1] ISO 1996-2:2007, Part 2
[2] The instruction for measuring environmental noise in areas subject to wind turbine noise issued by the Ministry of the Environment of Finland (Tuulivoimaloiden melutason mittaaminen altistuvassa kohteessa, Ympäristöhallinnon ohjeita 4/2014, Ympäristöministeriö, Rakennetun ympäristön osasto, Helsinki 2014, ISSN 1796-1653, see particularly section 4, pages 12 to 13)

1. An enclosure for a sound level meter, the enclosure comprising:
a microphone housing which is provided to a bottom surface of the enclosure, and
a stand which is configured to provide a clearance between the microphone housing and an installation surface on which the enclosure is to be placed.

2. The enclosure according to claim 1, wherein the microphone housing is configured to hold a microphone so that the transducer of the microphone is parallel to the surface or tangent of the installation surface on which the enclosure is to be placed.

3. The enclosure according to claim 1, wherein the microphone housing is configured to hold a microphone so that the clearance between the transducer of the microphone and the installation surface is 10 mm or less.

4. The enclosure according to claim 1, wherein the microphone housing is positioned on the bottom surface of the enclosure such that the center point or acoustic axis of the microphone when held in the microphone housing is offset from symmetry axes, preferably all symmetry axes, of an imaginary polygon which is formed by tangential lines and drawn on the projection of the enclosure on the installation surface on which the enclosure is to be placed.

5. The enclosure according to claim 1, wherein the enclosure is configured to be affixed to the installation surface.

6. The enclosure according to claim 1, wherein:
the stand comprises a leg or a plurality of legs distanced from each other, and wherein
the leg or legs has/have a rotationally non-symmetrical cross-section which exhibits a narrower tip and a wider distal end opposing the tip, wherein the tip points towards the microphone housing.

7. The enclosure according to claim 6, wherein the plurality of legs is positioned to the enclosure such that the center lines of the legs are offset from symmetry axes, preferably all symmetry axes, of an imaginary polygon which is formed by tangential lines and drawn on the projection of the enclosure on the installation surface on which the enclosure is to be placed.

8. The enclosure according to claim 1, wherein:
the microphone housing comprises an end surface defining an opening, and wherein
the at least one leg of the stand comprises an end surface which is parallel to the end surface of the microphone housing.

9. The enclosure according to claim 1, wherein the enclosure contains a space for the electronics used for operating the microphone.

10. The enclosure according to claim 1, wherein the enclosure is made of at least two interconnected components, wherein one of the at least two components acts as a bottom part which comprises the microphone housing.

11. The enclosure according to claim 1, wherein only the bottom surface of the enclosure comprises a microphone housing.

12. A sound level meter particularly for permanent installation, comprising the enclosure according to claim 1.

13. The sound level meter according to claim 12, wherein the sound level meter comprises a microphone fitted to the microphone housing such that the transducer of the microphone is parallel to the surface or tangent of the installation surface on which the enclosure is to be placed.

14. An additive manufacturing system comprising an additive manufacturing apparatus, at least one processing core, at least one memory including computer program code, the at least one memory and the computer program code being configured to, with the at least one processing core, cause the additive manufacturing apparatus to produce the enclosure according to claim 1.

15. A non-transitory computer readable medium comprising computer readable instructions that, when executed by the at least one processing core of an additive manufacturing system, cause an additive manufacturing apparatus of the additive manufacturing system to produce the enclosure according to claim 1.

16. The enclosure according to claim 4, wherein:
the stand comprises a leg or a plurality of legs distanced from each other, and wherein
the leg or legs has/have a rotationally non-symmetrical cross-section which exhibits a narrower tip and a wider distal end opposing the tip, wherein the tip points towards the microphone housing.

17. The enclosure according to claim 16, wherein the plurality of legs is positioned to the enclosure such that the center lines of the legs are offset from symmetry axes, preferably all symmetry axes, of an imaginary polygon which is formed by tangential lines and drawn on the projection of the enclosure on the installation surface on which the enclosure is to be placed.

18. The sound level meter according to claim 12, wherein the microphone housing is positioned on the bottom surface of the enclosure such that the center point or acoustic axis of the microphone when held in the microphone housing is offset from symmetry axes, preferably all symmetry axes, of an imaginary polygon which is formed by tangential lines and drawn on the projection of the enclosure on the installation surface on which the enclosure is to be placed.

19. The sound level meter according to claim 12, wherein:
the stand comprises a leg or a plurality of legs distanced from each other, and wherein
the leg or legs has/have a rotationally non-symmetrical cross-section which exhibits a narrower tip and a wider distal end opposing the tip, wherein the tip points towards the microphone housing.

20. The sound level meter according to claim 19, wherein the plurality of legs is positioned to the enclosure such that the center lines of the legs are offset from symmetry axes, preferably all symmetry axes, of an imaginary polygon which is formed by tangential lines and drawn on the projection of the enclosure on the installation surface on which the enclosure is to be placed.
